(19) United States
(12) Patent Application Publication
(10) Pub. No.: US 2026/0264411 A1
(43) Pub. Date: Sep. 10, 2026

(54) LIQUID EJECTION APPARATUS

(71) Applicant: SEIKO EPSON CORPORATION, TOKYO (JP)

(72) Inventors: So WARASHINA, HIGASHI HIROSHIMA-SHI (JP); Hiromichi NAKASHIMA, MATSUMOTO-SHI (JP); Masahiro KARASAWA, MATSUMOTO-SHI (JP); Kazutoshi SHIMIZU, OKAYA-SHI (JP)

(21) Appl. No.: 19/558,548

(22) Filed: Mar. 6, 2026

(30) Foreign Application Priority Data
Mar. 6, 2025 (JP) 2025-035228

(51) Int. Cl. B41J 2/175; B41J 25/00; B41J 29/00

(52) U.S. Cl. CPC B41J 2/17563; B41J 2/17596; B41J 25/001; B41J 29/00

(57) ABSTRACT

A liquid ejection apparatus includes: a mounting portion on which a filter unit provided in a supply flow path that supplies a liquid to a liquid ejection head is mounted, the filter unit includes a first introduction portion and a first lead-out portion, the mounting portion includes a second lead-out portion to which the first introduction portion is connected, and a second introduction portion to which the first lead-out portion is connected, the second introduction portion has a second introduction port, the second lead-out portion includes a second lead-out port opening in the same direction as the second introduction port, and a second lead-out valve configured to open and close the second lead-out port, and the second lead-out valve moves to an open position as the filter unit is mounted on the mounting portion, and moves to a closed position as the filter unit is detached from the mounting portion.

### CROSS REFERENCE TO RELATED APPLICATIONS

The present application is based on, and claims priority from JP Application Serial Number 2025-035228, filed March 6, 2025, the disclosure of which is hereby incorporated by reference herein in its entirety.

### BACKGROUND

### 1. Technical Field

The present disclosure relates to a liquid ejection apparatus such as a printer.

### 2. Related Art

For example, as in JP-A-2009-028979, there is a recording apparatus, which is an example of a liquid ejection apparatus that performs recording by ejecting ink, which is an example of a liquid from a recording head, which is an example of a liquid ejection head. The recording apparatus includes a supply tube, which is an example of a supply flow path, a filter unit, and a plurality of valves.

The supply tube forms a path for ink to be supplied to the recording head. The filter unit is detachably provided in the supply tube. The valves are provided upstream of the filter unit and downstream of the filter unit, respectively.

JP-A-2009-028979 is an example of the related art.

After performing an operation of closing the valve on the upstream side and the valve on the downstream side, a user detaches the filter unit from the supply tube and replaces the filter unit. Therefore, there is room for improvement in attachability and detachability of the filter unit.

### SUMMARY

A liquid ejection apparatus that solves the above problem includes: a liquid ejection head configured to eject a liquid; a supply flow path configured to supply the liquid to the liquid ejection head; a filter unit provided in the supply flow path; and a mounting portion on which the filter unit is detachably mounted, in which the filter unit includes a filter configured to collect foreign matter, a first introduction portion configured to introduce the liquid into the filter unit, and a first lead-out portion configured to lead out the liquid from the filter unit, the mounting portion includes a second lead-out portion to which the first introduction portion is connected, and a second introduction portion to which the first lead-out portion is connected, the second introduction portion has a second introduction port, the second lead-out portion includes a second lead-out port opening in the same direction as the second introduction port, and a second lead-out valve configured to open and close the second lead-out port, and the second lead-out valve moves to an open position as the filter unit is mounted on the mounting portion, and moves to a closed position as the filter unit is detached from the mounting portion.

### BRIEF DESCRIPTION OF THE DRAWINGS

FIG. 1 is a schematic diagram of a first embodiment of a liquid ejection apparatus.

FIG. 2 is a schematic cross-sectional view of a filter unit and a mounting portion before mounting.

FIG. 3 is a schematic cross-sectional view of the filter unit and the mounting portion during mounting.

FIG. 4 is a schematic cross-sectional view of the filter unit and the mounting portion during mounting.

FIG. 5 is a schematic cross-sectional view of the filter unit and the mounting portion in a mounted state.

FIG. 6 is a schematic diagram of a second embodiment of the liquid ejection apparatus.

### DESCRIPTION OF EMBODIMENTS

### First Embodiment

Hereinafter, a first embodiment of a liquid ejection apparatus will be described with reference to the drawings. The liquid ejection apparatus is, for example, an inkjet printer that performs printing by ejecting ink, which is an example of a liquid, onto a medium such as a sheet.

In the drawings, assuming that a liquid ejection apparatus 11 is placed on a horizontal plane, the direction of gravity is indicated by a Z axis, and directions along the horizontal plane are indicated by an X axis and a Y axis. The X axis, the Y axis, and the Z axis are perpendicular to each other. In the following description, a direction parallel to the Z axis is also referred to as a vertical direction Z.

### Liquid Ejection Apparatus

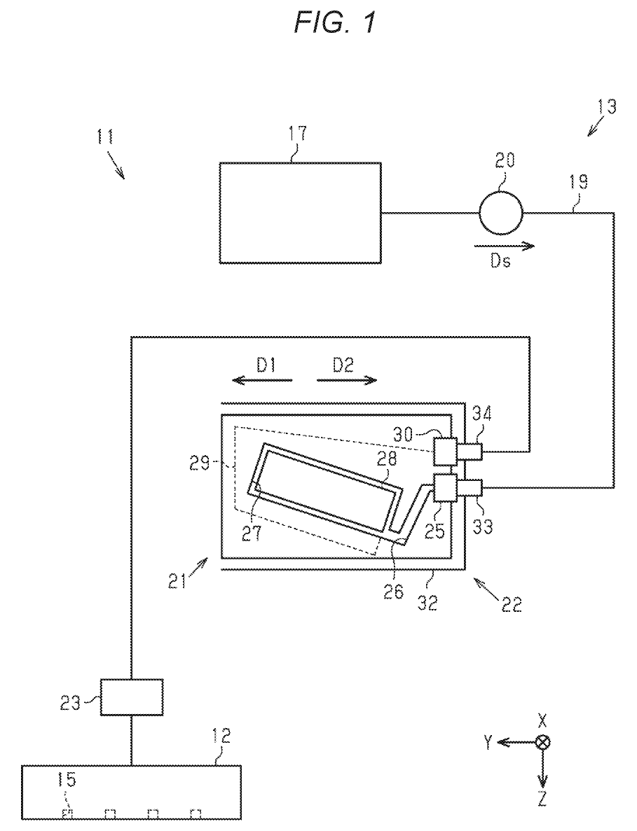

As illustrated in FIG. 1, the liquid ejection apparatus 11 includes a liquid ejection head 12 and a liquid supply apparatus 13.

The liquid ejection head 12 can eject a liquid. The liquid ejection head 12 includes one or more nozzles 15. The liquid ejection head 12 ejects the liquid from the nozzles 15 to perform printing on a medium (not illustrated).

### Liquid Supply Apparatus

The liquid ejection apparatus 11 may include a plurality of liquid supply apparatuses 13. Since the plurality of liquid supply apparatuses 13 have the same configuration, one liquid supply apparatus 13 is illustrated in FIG. 1.

The liquid supply apparatus 13 can be coupled to the liquid ejection head 12. The liquid supply apparatus 13 supplies the liquid from a liquid container 17 to the liquid ejection head 12. The plurality of liquid supply apparatuses 13 are connected to different liquid containers 17, respectively. The plurality of liquid containers 17 may contain different types of liquids. The different types of liquids are, for example, inks of different colors. The plurality of liquid supply apparatuses 13 supply the plurality of types of liquids to the liquid ejection head 12.

The liquid supply apparatus 13 may include a supply flow path 19, a supply pump 20, a filter unit 21, a mounting portion 22, and a pressure regulating mechanism 23.

An upstream end of the supply flow path 19 is connected to the liquid container 17. A downstream end of the supply flow path 19 is connected to the liquid ejection head 12. The supply flow path 19 supplies the liquid to the liquid ejection head 12. The liquid flows through the supply flow path 19 in a supply direction Ds.

The supply pump 20 applies a negative pressure to the liquid contained in the liquid container 17. The supply pump 20 leads out the liquid from the liquid container 17 to the supply flow path 19. The supply pump 20 pressurizes the led-out liquid to supply the liquid to the liquid ejection head 12.

The pressure regulating mechanism 23 can regulate the pressure in the liquid ejection head 12. The pressure regulating mechanism 23 is provided in the supply flow path 19 between the mounting portion 22 and the liquid ejection head 12. The pressure regulating mechanism 23 stabilizes the pressure of the liquid that is supplied to the nozzles 15 by regulating the pressure of the liquid pressurized and supplied. The pressure regulating mechanism 23 regulates the pressure of the liquid in the liquid ejection head 12 into pressure at which a meniscus is formed in the nozzle 15. The pressure regulating mechanism 23 opens the supply flow path 19 when downstream pressure is lower than predetermined pressure. For example, when the liquid is ejected from the nozzles 15 or the liquid is discharged from the nozzles 15, the liquid in the liquid ejection head 12 decreases and the pressure of the liquid decreases. When downstream negative pressure increases, the pressure regulating mechanism 23 opens the supply flow path 19 to supply the liquid to the liquid ejection head 12.

The filter unit 21 is provided in the supply flow path 19. The filter unit 21 may include a first introduction portion 25, an introduction flow path 26, a filter chamber 27, a filter 28, an lead-out flow path 29, and a first lead-out portion 30.

The filter chamber 27 accommodates a filter 28. The filter 28 partitions the filter chamber 27 into a pre-chamber and a post-chamber. That is, the filter chamber 27 has the pre-chamber and the post-chamber.

The filter 28 is for collecting foreign matter. The filter 28 may be a porous body, a nonwoven fabric, or the like. The filter 28 of the embodiment has a sheet shape. The filter 28 may have a cylindrical shape.

The introduction flow path 26 connects the first introduction portion 25 and the filter chamber 27. The introduction flow path 26 sends the liquid introduced from the first introduction portion 25 to the filter chamber 27. Specifically, the introduction flow path 26 sends the liquid to the pre-chamber partitioned by the filter 28.

The lead-out flow path 29 connects the filter chamber 27 and the first lead-out portion 30. The lead-out flow path 29 is connected to the post-chamber partitioned by the filter 28. The lead-out flow path 29 sends the liquid passing through the filter 28 to the first lead-out portion 30.

The filter unit 21 is detachably mounted on the mounting portion 22. The mounting portion 22 may include a case portion 32, a second lead-out portion 33, and a second introduction portion 34.

The case portion 32 can accommodate the filter unit 21. One case portion 32 may be provided for a plurality of liquid supply apparatuses 13. The case portion 32 may be capable of accommodating the plurality of filter units 21. Each filter unit 21 may be individually attachable and detachable. The filter unit 21 is separated from the case portion 32 by moving in a detachment direction D1. The filter unit 21 is accommodated in the case portion 32 by moving in a mounting direction D2. The mounting direction D2 is a direction opposite to the detachment direction D1. The mounting direction D2 and the detachment direction D1 of the embodiment are directions parallel to the Y axis.

### First Introduction Portion

As illustrated in FIG. 1, when the filter unit 21 is mounted on the mounting portion 22, the first introduction portion 25 is located ahead of the second lead-out portion 33 in the detachment direction D1. The first introduction portion 25 is connected to the second lead-out portion 33. The first introduction portion 25 introduces the liquid into the filter unit 21.

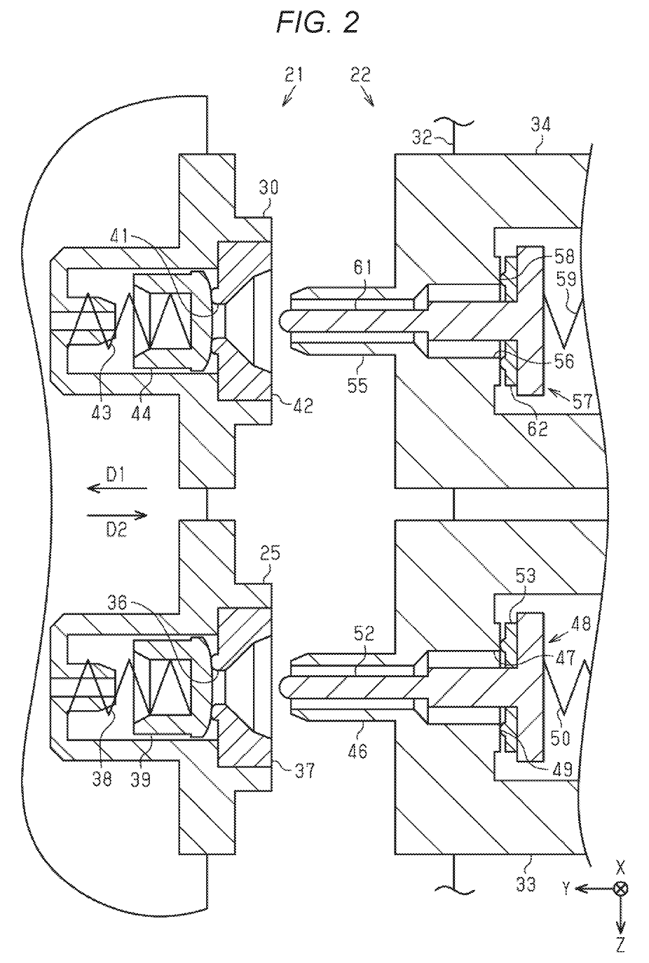

As illustrated in FIG. 2, the first introduction portion 25 may include a first introduction port 36, a first introduction valve seat 37, a first introduction spring 38, and a first introduction valve 39.

The first introduction port 36 may be provided in the first introduction valve seat 37. The first introduction valve seat 37 has the first introduction port 36 at the center. The first introduction valve seat 37 may be a ring-shaped elastic member. The first introduction valve seat 37 exposes a part of the first introduction valve 39.

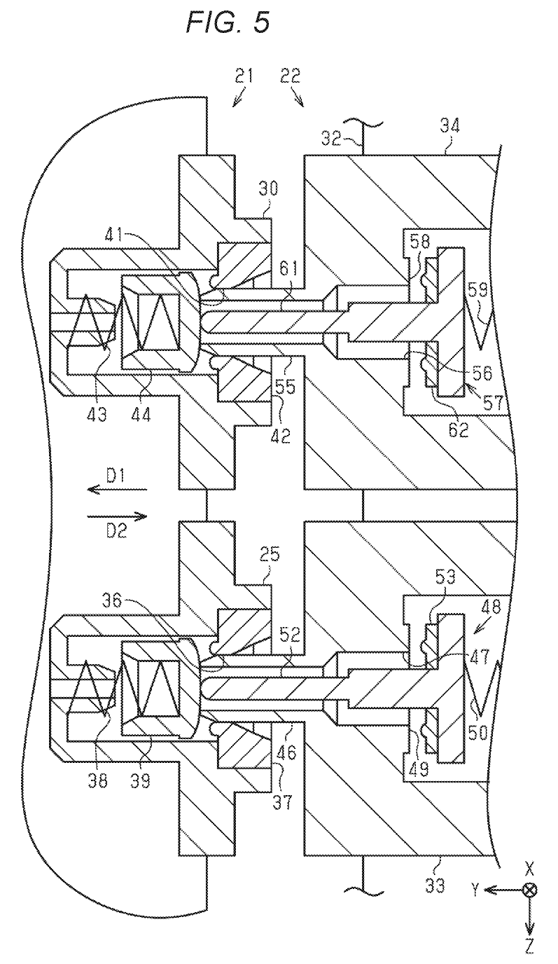

The first introduction spring 38 presses the first introduction valve 39 in the mounting direction D2. The first introduction spring 38 closes the first introduction port 36 by pressing the first introduction valve 39 against the first introduction valve seat 37. The first introduction valve 39 is movable between a closed position illustrated in FIG. 2 where the first introduction port 36 is closed and an open position illustrated in FIG. 5 where the first introduction port 36 is opened. The first introduction valve 39 can open and close the first introduction port 36.

### First Lead-Out Portion

As illustrated in FIG. 1, when the filter unit 21 is mounted on the mounting portion 22, the first lead-out portion 30 is located ahead of the second introduction portion 34 in the detachment direction D1. The first lead-out portion 30 is connected to the second introduction portion 34. The first lead-out portion 30 leads out the liquid from the filter unit 21. The first lead-out portion 30 may be located above the first introduction portion 25 in the vertical direction Z.

As illustrated in FIG. 2, the first lead-out portion 30 may include a first lead-out port 41, a first lead-out valve seat 42, a first lead-out spring 43, and a first lead-out valve 44.

The first lead-out port 41 may be provided in the first lead-out valve seat 42. The first lead-out valve seat 42 has the first lead-out port 41 at the center. The first lead-out valve seat 42 may be a ring-shaped elastic member. The first lead-out valve seat 42 exposes a part of the first lead-out valve 44.

The first lead-out spring 43 presses the first lead-out valve 44 in the mounting direction D2. The first lead-out spring 43 closes the first lead-out port 41 by pressing the first lead-out valve 44 against the first lead-out valve seat 42. The first lead-out valve 44 is movable between a closed position illustrated in FIG. 2 where the first lead-out port 41 is closed and an open position illustrated in FIG. 5 where the first lead-out port 41 is opened. The first lead-out valve 44 can open and close the first lead-out port 41.

### Second Lead-Out Portion

The second lead-out portion 33 may include a first pressing portion 46, a second lead-out port 47, a second lead-out valve 48, a second lead-out valve seat 49, and a second lead-out spring 50.

The first pressing portion 46 may have a cylindrical shape. The first pressing portion 46 extends in the detachment direction D1. The diameter of a tip-end portion of the first pressing portion 46 is larger than the diameter of the first introduction port 36.

The second lead-out valve 48 may include an lead-out shaft portion 52 and an lead-out seal portion 53. The lead-out shaft portion 52 extends in the detachment direction D1 in the first pressing portion 46. The diameter of a tip-end portion of the lead-out shaft portion 52 is smaller than the diameter of the first introduction port 36. The lead-out seal portion 53 is provided on a base-end side of the lead-out shaft portion 52. The lead-out seal portion 53 has elasticity.

The second lead-out valve seat 49 has the second lead-out port 47.

The second lead-out spring 50 presses the second lead-out valve 48 in the detachment direction D1. Force of the second lead-out spring 50 pressing the second lead-out valve 48 is weaker than force of the first introduction spring 38 pressing the first introduction valve 39. The second lead-out spring 50 presses the second lead-out valve 48 to press the lead-out seal portion 53 against the second lead-out valve seat 49, thereby closing the second lead-out port 47. The second lead-out valve 48 is movable between a closed position illustrated in FIG. 2 where the second lead-out port 47 is closed and an open position illustrated in FIG. 5 where the second lead-out port 47 is opened. The second lead-out valve 48 can open and close the second lead-out port 47. When the second lead-out valve 48 closes the second lead-out port 47, a tip end of the lead-out shaft portion 52 protrudes in the detachment direction D1 from a tip end of the first pressing portion 46.

### Second Introduction Portion

The second introduction portion 34 may include a second pressing portion 55, a second introduction port 56, a second introduction valve 57, a second introduction valve seat 58, and a second introduction spring 59. The second introduction port 56 opens in the same direction as the second lead-out port 47. The second introduction port 56 and the second lead-out port 47 open in the detachment direction D1. The second introduction portion 34 and the second lead-out portion 33 may be located at the same position in the detachment direction D1.

The second pressing portion 55 may have a cylindrical shape. The second pressing portion 55 extends in the detachment direction D1. The diameter of a tip-end portion of the second pressing portion 55 is larger than the diameter of the first lead-out port 41.

The second introduction valve 57 may include an introduction shaft portion 61 and an introduction seal portion 62. The introduction shaft portion 61 extends in the detachment direction D1 in the second pressing portion 55. The diameter of a tip-end portion of the introduction shaft portion 61 is smaller than the diameter of the first lead-out port 41. The introduction seal portion 62 is provided on a base-end side of the introduction shaft portion 61. The introduction seal portion 62 has elasticity.

The second introduction valve seat 58 has the second introduction port 56.

The second introduction spring 59 presses the second introduction valve 57 in the detachment direction D1. Force of the second introduction spring 59 pressing the second introduction valve 57 is weaker than force of the first lead-out spring 43 pressing the first lead-out valve 44. The second introduction spring 59 presses the second introduction valve 57 to press the introduction seal portion 62 against the second introduction valve seat 58, thereby closing the second introduction port 56. The second introduction valve 57 is movable between a closed position illustrated in FIG. 2 where the second introduction port 56 is closed and an open position illustrated in FIG. 5 where the second introduction port 56 is opened. The second introduction valve 57 can open and close the second introduction port 56. When the second introduction valve 57 closes the second introduction port 56, a tip end of the introduction shaft portion 61 protrudes in the detachment direction D1 from a tip end of the second pressing portion 55.

### Action of First Embodiment

Action of the embodiment will be described.

As illustrated in FIGS. 2 to 5, when the filter unit 21 is mounted on the mounting portion 22, an operator causes the first introduction portion 25 to face the second lead-out portion 33 and causes the first lead-out portion 30 to face the second introduction portion 34. The operator mounts the filter unit 21 on the mounting portion 22 by moving the filter unit 21 in the mounting direction D2. When the filter unit 21 is mounted, the first introduction portion 25 is connected to the second lead-out portion 33, and the first lead-out portion 30 is connected to the second introduction portion 34.

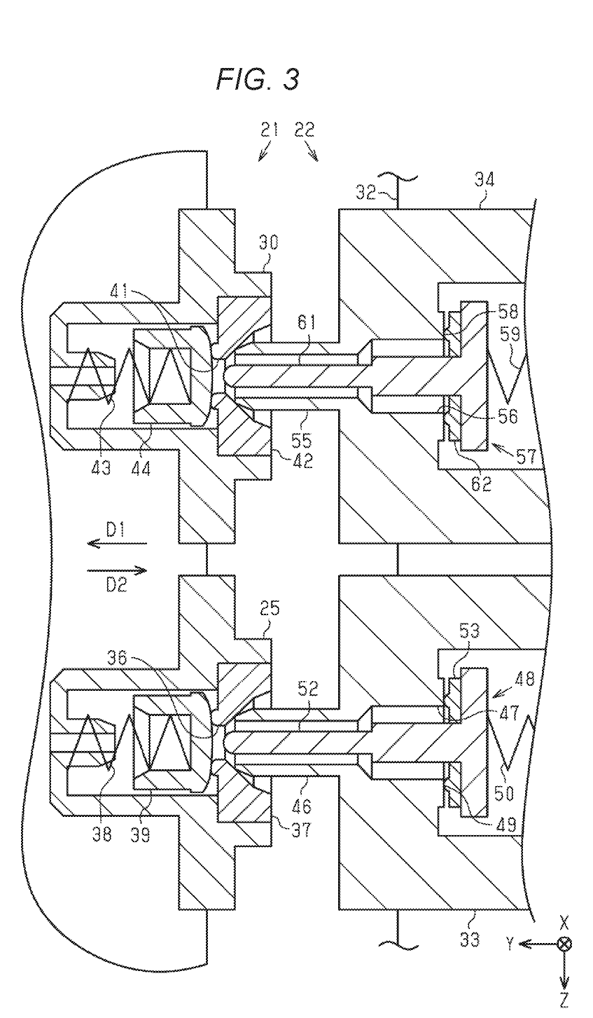

As illustrated in FIG. 3, the filter unit 21 moving in the mounting direction D2 seals the inside of the first pressing portion 46 by the first introduction valve seat 37 coming into contact with the tip end of the first pressing portion 46. The filter unit 21 moving in the mounting direction D2 seals the inside of the second pressing portion 55 by the first lead-out valve seat 42 coming into contact with the tip end of the second pressing portion 55.

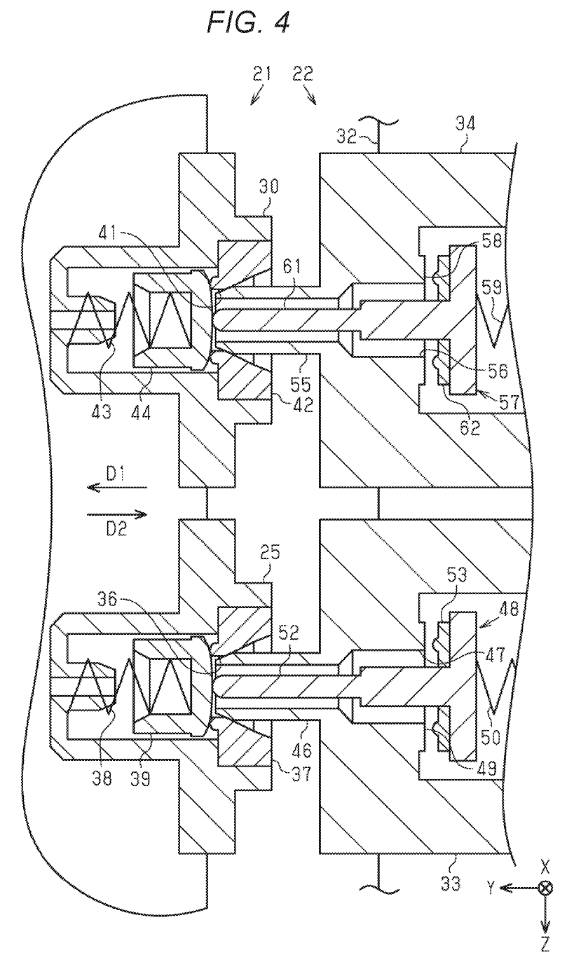

As illustrated in FIG. 4, when the filter unit 21 further moves in the mounting direction D2, the first introduction port 36 is pressed and widened by the first pressing portion 46. The first introduction valve 39 comes into contact with the second lead-out valve 48. Since the first introduction spring 38 is stronger than the second lead-out spring 50, the first introduction valve 39 presses the second lead-out valve 48 in the mounting direction D2 to move the second lead-out valve 48 to the open position. That is, when the filter unit 21 is mounted on the mounting portion 22, the second lead-out valve 48 is pressed by the first introduction valve 39 to move to the open position. The second lead-out valve 48 moves to the open position as the filter unit 21 is mounted on the mounting portion 22. When the filter unit 21 moves in the mounting direction D2, the second lead-out valve 48 moves in the mounting direction D2 and is located at the open position.

Similarly to the first introduction portion 25, in the first lead-out portion 30, the first lead-out port 41 is pressed and widened by the second pressing portion 55. The first lead-out valve 44 comes into contact with the second introduction valve 57. Since the first lead-out spring 43 is stronger than the second introduction spring 59, the first lead-out valve 44 presses the second introduction valve 57 in the mounting direction D2 to move the second introduction valve 57 to the open position. That is, when the filter unit 21 is mounted on the mounting portion 22, the second introduction valve 57 is pressed by the first lead-out valve 44 to move to the open position. The second introduction valve 57 moves to the open position as the filter unit 21 is mounted on the mounting portion 22. When the filter unit 21 moves in the mounting direction D2, the second introduction valve 57 moves in the mounting direction D2 and is located at the open position.

As illustrated in FIG. 5, when the filter unit 21 further moves in the mounting direction D2, the first introduction valve 39 comes into contact with the first pressing portion 46 and the movement is restricted. In other words, the first pressing portion 46 presses the first introduction valve 39 to separate the first introduction valve 39 from the first introduction valve seat 37. The first pressing portion 46 moves the first introduction valve 39 relative to the first introduction valve seat 37 in the detachment direction D1. The first pressing portion 46 moves the first introduction valve 39 to the open position. Therefore, when the filter unit 21 is mounted on the mounting portion 22, the first introduction valve 39 is pressed by the first pressing portion 46 to move to the open position. The first introduction valve 39 moves to the open position as the filter unit 21 is mounted on the mounting portion 22.

Similarly to the first introduction portion 25, the first lead-out portion 30 is restricted from moving by the first lead-out valve 44 coming into contact with the second pressing portion 55. In other words, the second pressing portion 55 presses the first lead-out valve 44 to separate the first lead-out valve 44 from the first lead-out valve seat 42. The second pressing portion 55 moves the first lead-out valve 44 relative to the first lead-out valve seat 42 in the detachment direction D1. The second pressing portion 55 moves the first lead-out valve 44 to the open position. Therefore, when the filter unit 21 is mounted on the mounting portion 22, the first lead-out valve 44 is pressed by the second pressing portion 55 to move to the open position. The first lead-out valve 44 moves to the open position as the filter unit 21 is mounted on the mounting portion 22.

When the filter unit 21 is mounted on the mounting portion 22, the first introduction portion 25 and the second lead-out portion 33 operate in the order of sealing of the first pressing portion 46, opening of the second lead-out port 47, and opening of the first introduction port 36. Since the first pressing portion 46 is sealed before the second lead-out port 47 is opened, the possibility that the liquid supplied from the supply pump 20 leaks is reduced.

Similarly, the first lead-out portion 30 and the second introduction portion 34 operate in the order of sealing of the second pressing portion 55, opening of the second introduction port 56, and opening of the first lead-out port 41. Since the second pressing portion 55 is sealed before the second introduction port 56 is opened, the possibility that the liquid leaks from the supply flow path 19 downstream of the filter unit 21 is reduced.

When the filter unit 21 is mounted, the second lead-out valve 48, the first introduction valve 39, the first lead-out valve 44, and the second introduction valve 57 are located at the open position. Therefore, the liquid pressurized and supplied by the supply pump 20 is sent to the liquid ejection head 12 via the filter unit 21.

When detaching the filter unit 21 from the mounting portion 22, the operator moves the filter unit 21 in the detachment direction D1.

As illustrated in FIG. 4, in the filter unit 21 moving in the detachment direction D1, the first introduction valve seat 37 moving in the detachment direction D1 comes into contact with the first introduction valve 39 pressed by the first introduction spring 38. That is, the first introduction valve 39 moves relative to the first introduction valve seat 37 to the closed position. The first introduction valve 39 moves to the closed position as the filter unit 21 is detached from the mounting portion 22.

Similarly to the first introduction portion 25, in the first lead-out portion 30, the first lead-out valve seat 42 moving in the detachment direction D1 comes into contact with the first lead-out valve 44 pressed by the first lead-out spring 43. That is, the first lead-out valve 44 moves relative to the first lead-out valve seat 42 to the closed position. The first lead-out valve 44 moves to the closed position as the filter unit 21 is detached from the mounting portion 22.

As illustrated in FIG. 3, when the filter unit 21 further moves in the detachment direction D1, the second lead-out valve 48 is pressed by the second lead-out spring 50 and moves in the detachment direction D1. When the filter unit 21 moves in the detachment direction D1, the second lead-out valve 48 moves in the detachment direction D1 and is located at the closed position. The second lead-out valve 48 moves to the closed position as the filter unit 21 is detached from the mounting portion 22.

Similarly to the second lead-out portion 33, in the second introduction portion 34, the second introduction valve 57 is pressed by the second introduction spring 59 and moves in the detachment direction D1. When the filter unit 21 moves in the detachment direction D1, the second introduction valve 57 moves in the detachment direction D1 and is located at the closed position. The second introduction valve 57 moves to the closed position as the filter unit 21 is detached from the mounting portion 22.

When the filter unit 21 is detached from the mounting portion 22, the first introduction portion 25 and the second lead-out portion 33 operate in the order of closing of the first introduction port 36, closing of the second lead-out port 47, and opening of the first pressing portion 46. Similarly, the first lead-out portion 30 and the second introduction portion 34 operate in the order of closing of the first lead-out port 41, closing of the second introduction port 56, and opening of the second pressing portion 55.

When the filter unit 21 is detached, the second lead-out valve 48, the first introduction valve 39, the first lead-out valve 44, and the second introduction valve 57 are located at the closed positions. Therefore, the liquid in the supply flow path 19 is maintained in a pressurized state. The filter unit 21 can hold the liquid therein.

### Effects of First Embodiment

Effects of the embodiment will be described.

(1-1) The second lead-out port 47 opens in the same direction as the second introduction port 56. Therefore, the direction in which the second lead-out portion 33 and the first introduction portion 25 are attached and detached can be aligned with the direction in which the second introduction portion 34 and the first lead-out portion 30 are attached and detached. That is, by moving the filter unit 21, the connecting state between the second lead-out portion 33 and the first introduction portion 25 and the connecting state between the second introduction portion 34 and the first lead-out portion 30 can be easily changed. The second lead-out valve 48 opens and closes the second lead-out port 47 as the filter unit 21 is attached and detached. Therefore, it is possible to easily replace the filter unit 21 as compared with a case where the operator opens and closes the valves.

(1-2) The first introduction valve 39 moves to the closed position as the filter unit 21 is detached. Therefore, it is possible to reduce the possibility that the liquid leaks from the detached filter unit 21.

(1-3) When the filter unit 21 is mounted, the first introduction valve 39 moves the second lead-out valve 48 to the open position, and is pressed by the first pressing portion 46 to move to the open position. Therefore, it is possible to smoothly mount the filter unit 21 while suppressing the leakage of the liquid.

(1-4) When the filter unit 21 moves, the second lead-out valve 48 moves in the same direction as the filter unit 21. Therefore, the second lead-out valve 48 can be smoothly opened and closed in accordance with the movement of the filter unit 21.

(1-5) The first introduction portion 25 and the first lead-out portion 30 provided in the filter unit 21 are located ahead of the second lead-out portion 33 and the second introduction portion 34 provided in the mounting portion 22 in the detachment direction D1. Therefore, by moving the filter unit 21 mounted on the mounting portion 22 in the detachment direction D1, the first introduction portion 25 and the first lead-out portion 30 can be easily separated from the second lead-out portion 33 and the second introduction portion 34.

(1-6) The filter unit 21 accommodated in the case portion 32 is separated from the case portion 32 by moving in the detachment direction D1. The filter unit 21 is accommodated in the case portion 32 by moving in the mounting direction D2 opposite to the detachment direction D1. Therefore, for example, compared to a case where the filter unit 21 is separated from the case portion 32 by moving in another direction after moving in one direction, the filter unit 21 can be attached and detached by a simple operation.

(1-7) The plurality of filter units 21 that can be accommodated in the case portion 32 are individually attachable and detachable. Therefore, for example, the filter unit 21 that needs to be replaced can be selected and replaced.

(1-8) The second introduction valve 57 moves to the closed position as the filter unit 21 is detached. Therefore, it is possible to reduce the possibility that the liquid leaks from the supply flow path 19 from which the filter unit 21 is detached.

(1-9) The first lead-out valve 44 moves to the closed position as the filter unit 21 is detached. Therefore, it is possible to reduce the possibility that the liquid leaks from the detached filter unit 21.

(1-10) When the filter unit 21 is mounted, the first lead-out valve 44 moves the second introduction valve 57 to the open position, and is pressed by the second pressing portion 55 to move to the open position. Therefore, it is possible to smoothly mount the filter unit 21 while suppressing the leakage of the liquid.

### Second Embodiment

Next, a second embodiment of the liquid ejection apparatus will be described with reference to the drawings. The second embodiment is different from the first embodiment in the configurations of the mounting portion and the filter unit. Since the other points are substantially the same as those of the first embodiment, the same reference numerals are given to the same configurations, and redundant description will be omitted.

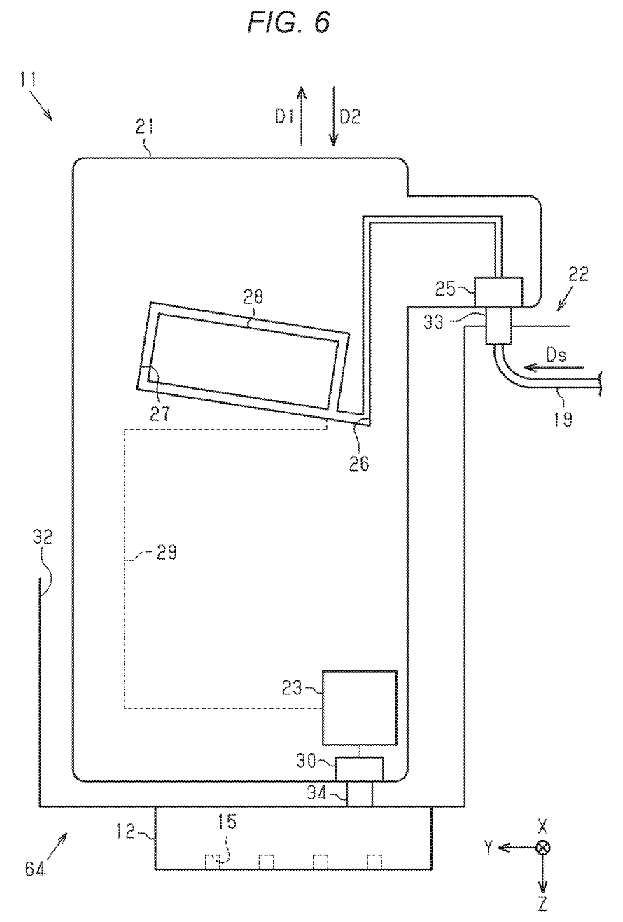

As illustrated in FIG. 6, the liquid ejection apparatus 11 may include a carriage 64. The carriage 64 moves while supporting the liquid ejection head 12. In the vertical direction Z, the liquid ejection head 12 may be provided below the carriage 64. The carriage 64 may reciprocate the liquid ejection head 12 along the X axis. The liquid ejection head 12 may perform printing on the medium by ejecting the liquid while moving.

The mounting portion 22 may be provided on the carriage 64. In the vertical direction Z, the mounting portion 22 may be provided on the carriage 64. The mounting direction D2 of the embodiment is the same direction as the vertical direction Z. The mounting direction D2 and the detachment direction D1 are directions different from the movement direction of the carriage 64.

The filter unit 21 may include the pressure regulating mechanism 23. The pressure regulating mechanism 23 is located downstream of the filter 28 in the liquid supply direction Ds. The pressure regulating mechanism 23 is provided in the lead-out flow path 29.

The first introduction portion 25 and the first lead-out portion 30 may be located at different positions in the detachment direction D1. The first introduction portion 25 may be located above the first lead-out portion 30 in the vertical direction Z. The first introduction portion 25 may be located above the filter 28. The first lead-out portion 30 may be located downstream of the filter 28.

The second lead-out portion 33 and the second introduction portion 34 may be located at different positions in the detachment direction D1. The second lead-out portion 33 may be located above the second introduction portion 34 in the vertical direction Z. The second lead-out portion 33 may be located above the pressure regulating mechanism 23. The second introduction portion 34 may be located below the pressure regulating mechanism 23.

### Action of Second Embodiment

Action of the embodiment will be described.

As illustrated in FIG. 6, when the filter unit 21 is mounted on the mounting portion 22, an operator causes the first introduction portion 25 to face the second lead-out portion 33 and causes the first lead-out portion 30 to face the second introduction portion 34. The operator mounts the filter unit 21 on the mounting portion 22 by moving the filter unit 21 in the mounting direction D2. When the filter unit 21 is mounted, the first introduction portion 25 is connected to the second lead-out portion 33, and the first lead-out portion 30 is connected to the second introduction portion 34. The second lead-out valve 48, the first introduction valve 39, the first lead-out valve 44, and the second introduction valve 57 move to the open position.

When detaching the filter unit 21 from the mounting portion 22, the operator moves the filter unit 21 in the detachment direction D1. When the filter unit 21 is detached, the connection between the second lead-out portion 33 and the first introduction portion 25 is released, and the connection between the second introduction portion 34 and the first lead-out portion 30 is released. The second lead-out valve 48, the first introduction valve 39, the first lead-out valve 44, and the second introduction valve 57 move to the closed position.

### Effects of Second Embodiment

Effects of the embodiment will be described.

(2-1) The position of the second lead-out portion 33 and the position of the second introduction portion 34 are different in the detachment direction D1. Therefore, the degree of freedom in design can be increased.

(2-2) The mounting portion 22 is provided on the carriage 64. Therefore, by moving the carriage 64, the filter unit 21 can be easily moved to, for example, a position where the filter unit 21 is easily attached and detached.

(2-3) The first introduction portion 25 is located above the first lead-out portion 30. The first lead-out portion 30 sends the liquid led out from the filter unit 21 to the liquid ejection head 12. Therefore, the supply flow path 19 that supplies the liquid to the filter unit 21 can be easily routed at a position away from the liquid ejection head 12.

(2-4) The filter unit 21 includes the pressure regulating mechanism 23 located downstream of the filter 28. The pressure regulating mechanism 23 can regulate the pressure in the liquid ejection head 12. That is, for example, when the liquid ejection head 12 ejects the liquid and the pressure in the liquid ejection head 12 changes, the pressure regulating mechanism 23 supplies the liquid and regulates the pressure. The pressure regulating mechanism 23 stops the supply of the liquid when the liquid ejection head 12 does not eject the liquid. Therefore, when the filter unit 21 is detached, since the pressure regulating mechanism 23 stops the supply of the liquid, it is possible to reduce the possibility that the liquid leaks from the detached filter unit 21.

### Modifications

The embodiment can be implemented with the following modifications. The embodiment and the following modifications can be implemented in combination with each other as long as no technical inconsistencies are involved.

In the first embodiment, the first introduction portion 25 may be located above the first lead-out portion 30.

In the second embodiment, the first introduction portion 25 may be located below the first lead-out portion 30.

In the first embodiment, the mounting portion 22 may be provided on the carriage 64.

One filter unit 21 may be provided for the plurality of liquid supply apparatuses 13. The filter unit 21 may include a plurality of sets of the first introduction portion 25, the introduction flow path 26, the filter chamber 27, the filter 28, the lead-out flow path 29, and the first lead-out portion 30. The pressure regulating mechanisms 23 may be provided in the plurality of lead-out flow paths 29, respectively.

The second lead-out portion 33 may not include the first pressing portion 46. The second lead-out portion 33 may include a stopper that restricts movement of the second lead-out valve 48 that has moved to the open position in the mounting direction D2. When the second lead-out valve 48 comes into contact with the stopper, the movement of the first introduction valve 39 pressing the second lead-out valve 48 is restricted. The first introduction valve 39 may move to the open position so as to be pressed by the second lead-out valve 48. Similarly, the second introduction portion 34 may not include the second pressing portion 55.

In the second embodiment, the first lead-out portion 30 and the second introduction portion 34 are located downstream of the pressure regulating mechanism 23 in the supply direction Ds. That is, the liquid passing through the first lead-out portion 30 and the second introduction portion 34 has a negative pressure. Therefore, even when the connection between the first lead-out portion 30 and the second introduction portion 34 is released, the liquid is less likely to spray out. Therefore, the first lead-out portion 30 may not include the first lead-out valve 44 and the first lead-out spring 43. The second introduction portion 34 may not include the second introduction valve 57 and the second introduction spring 59.

At least one of the first introduction valve 39, the first lead-out valve 44, and the second introduction valve 57 may be a valve that is opened and closed by the operator.

The mounting portion 22 may not include the case portion 32. The filter unit 21 mounted on the mounting portion 22 may be supported by a member different from the mounting portion 22.

The detachment direction D1 in which the filter unit 21 is moved when the filter unit 21 is detached from the case portion 32 may be different from the direction in which the filter unit 21 is moved when the connection between the first introduction portion 25 and the second lead-out portion 33 and the connection between the first lead-out portion 30 and the second introduction portion 34 are released.

The liquid ejection apparatus 11 may be a liquid ejection apparatus that jets or ejects liquids other than ink. The state of the liquid to be ejected from the liquid ejection apparatus as a minute amount of droplet includes a particle state, a teardrop state, and a state of tailing like a thread. The liquid mentioned here may be any material that can be ejected from the liquid ejection apparatus. For example, the liquid may be any substance in a liquid phase and includes a liquid material high or low in viscosity, sol, gel water, other inorganic solvents, organic solvents, solutions, and a fluid material such as a liquid resin, liquid metal, and metal melt. The liquid includes not only a liquid as one state of a substance, but also a liquid obtained by dissolving, dispersing, or mixing particles of a functional material formed of a solid substance such as pigments or metal particles in a solvent. Representative examples of the liquid include the ink described in the above embodiment and a liquid crystal. Here, the term "ink" includes various types of liquid compositions such as general water-based ink, oil-based ink, gel ink, and hot melt ink. Specific examples of the liquid ejection apparatus include an apparatus that ejects a liquid containing, in a dispersed or dissolved form, a material such as an electrode material or a coloring material used for manufacturing, for example, a liquid crystal display, an electroluminescence display, a surface-emitting display, and a color filter. The liquid ejection apparatus may be an apparatus that ejects a bioorganic substance used for manufacturing a biochip, an apparatus that is used as a precision pipette and ejects a liquid to be a sample, a textile printing apparatus, a micro dispenser, or the like. The liquid ejection apparatus may be an apparatus that ejects lubricating oil to a precision machine such as a timepiece or a camera in a pinpoint manner, or an apparatus that ejects a liquid of a transparent resin such as an ultraviolet curable resin onto a substrate in order to form a minute hemispherical lens, an optical lens, or the like, which are used for an optical communication element or the like. The liquid ejection apparatus may be an apparatus that ejects an etching liquid such as acid or alkali in order to etch a substrate or the like.

### Definitions

The expression "at least one" used in the present specification refers to "one or more" of desired options. For example, the expression "at least one" used in the present specification refers to "only one option" or "both of two options" when the number of options is two. As another example, the expression "at least one" used in the present specification means "only one option", "a combination of any two options", or "a combination of any three or more options" when the number of options is three or more.

### Appendices

Technical ideas figured out from the embodiments and the modifications described above and action effects thereof are described below.

[1] A liquid ejection apparatus includes: a liquid ejection head configured to eject a liquid; a supply flow path configured to supply the liquid to the liquid ejection head; a filter unit provided in the supply flow path; and a mounting portion on which the filter unit is detachably mounted, in which the filter unit includes a filter configured to collect foreign matter, a first introduction portion configured to introduce the liquid into the filter unit, and a first lead-out portion configured to lead out the liquid from the filter unit, the mounting portion includes a second lead-out portion to which the first introduction portion is connected, and a second introduction portion to which the first lead-out portion is connected, the second introduction portion has a second introduction port, the second lead-out portion includes a second lead-out port opening in the same direction as the second introduction port, and a second lead-out valve configured to open and close the second lead-out port, and the second lead-out valve moves to an open position as the filter unit is mounted on the mounting portion, and moves to a closed position as the filter unit is detached from the mounting portion.

According to this configuration, the second lead-out port opens in the same direction as the second introduction port. Therefore, the direction in which the second lead-out portion and the first introduction portion are attached and detached can be aligned with the direction in which the second introduction portion and the first lead-out portion are attached and detached. That is, by moving the filter unit, the connecting state between the second lead-out portion and the first introduction portion and the connecting state between the second introduction portion and the first lead-out portion can be easily changed. The second lead-out valve opens and closes the second lead-out port as the filter unit is attached and detached. Therefore, it is possible to easily replace the filter unit as compared with a case where the operator opens and closes the valves.

[2] In the liquid ejection apparatus according to the above [1], the first introduction portion may include a first introduction port and a first introduction valve configured to open and close the first introduction port, and the first introduction valve may move to an open position as the filter unit is mounted on the mounting portion, and may move to a closed position as the filter unit is detached from the mounting portion.

According to this configuration, the first introduction valve moves to the closed position as the filter unit is detached. Therefore, it is possible to reduce the possibility that the liquid leaks from the detached filter unit.

[3] In the liquid ejection apparatus according to the above [2], the second lead-out portion may include a first pressing portion, and when the filter unit is mounted on the mounting portion, the second lead-out valve may be pressed by the first introduction valve to move to the open position, and the first introduction valve may be pressed by the first pressing portion to move to the open position.

According to this configuration, when the filter unit is mounted, the first introduction valve moves the second lead-out valve to the open position, and is pressed by the first pressing portion to move to the open position. Therefore, it is possible to smoothly mount the filter unit while suppressing the leakage of the liquid.

[4] In the liquid ejection apparatus according to any one of the above [1] to [3], when the filter unit moves in a detachment direction, the second lead-out valve may move in the detachment direction and may be located at the closed position, and when the filter unit moves in a mounting direction opposite to the detachment direction, the second lead-out valve may move in the mounting direction and may be located at the open position.

According to this configuration, when the filter unit moves, the second lead-out valve moves in the same direction as the filter unit. Therefore, the second lead-out valve can be smoothly opened and closed in accordance with the movement of the filter unit.

[5] In the liquid ejection apparatus according to any one of the above [1] to [4], when the filter unit is mounted on the mounting portion, the first introduction portion may be located ahead of the second lead-out portion in a detachment direction, and the first lead-out portion may be located ahead of the second introduction portion in the detachment direction.

According to this configuration, the first introduction portion and the first lead-out portion provided in the filter unit are located ahead of the second lead-out portion and the second introduction portion provided in the mounting portion in the detachment direction. Therefore, by moving the filter unit mounted on the mounting portion in the detachment direction, the first introduction portion and the first lead-out portion can be easily separated from the second lead-out portion and the second introduction portion.

[6] In the liquid ejection apparatus according to the above [5], the second lead-out portion and the second introduction portion may be located at different positions in the detachment direction.

According to this configuration, the position of the second lead-out portion and the position of the second introduction portion are different in the detachment direction. Therefore, the degree of freedom in design can be increased.

[7] In the liquid ejection apparatus according to the above [4], the mounting portion may include a case portion configured to accommodate the filter unit, and the filter unit may be separated from the case portion by moving in the detachment direction and accommodated in the case portion by moving in the mounting direction.

According to this configuration, the filter unit accommodated in the case portion is separated from the case portion by moving in the detachment direction. The filter unit is accommodated in the case portion by moving in the mounting direction opposite to the detachment direction. Therefore, for example, compared to a case where the filter unit is separated from the case portion by moving in another direction after moving in one direction, the filter unit can be attached and detached by a simple operation.

[8] In the liquid ejection apparatus according to the above [7], a plurality of the filter units may be provided, the case portion may be configured to accommodate the plurality of filter units, and each of the filter units may be individually attachable and detachable.

According to this configuration, the plurality of filter units that can be accommodated in the case portion are individually attachable and detachable. Therefore, for example, the filter unit that needs to be replaced can be selected and replaced.

[9] In the liquid ejection apparatus according to any one of the above [1] to [8], the second introduction portion may include a second introduction valve configured to open and close the second introduction port, and the second introduction valve may move to an open position as the filter unit is mounted on the mounting portion, and may move to a closed position as the filter unit is detached from the mounting portion.

According to this configuration, the second introduction valve moves to the closed position as the filter unit is detached. Therefore, it is possible to reduce the possibility that the liquid leaks from the supply flow path from which the filter unit is detached.

[10] In the liquid ejection apparatus according to the above [9], the first lead-out portion may include a first lead-out port and a first lead-out valve configured to open and close the first lead-out port, and the first lead-out valve may move to an open position as the filter unit is mounted on the mounting portion, and may move to a closed position as the filter unit is detached from the mounting portion.

According to this configuration, the first lead-out valve moves to the closed position as the filter unit is detached. Therefore, it is possible to reduce the possibility that the liquid leaks from the detached filter unit.

[11] In the liquid ejection apparatus according to the above , the second introduction portion may include a second pressing portion, and when the filter unit is mounted on the mounting portion, the second introduction valve may be pressed by the first lead-out valve to move to the open position, and the first lead-out valve may be pressed by the second pressing portion to move to the open position.

According to this configuration, when the filter unit is mounted, the first lead-out valve moves the second introduction valve to the open position, and is pressed by the second pressing portion to move to the open position. Therefore, it is possible to smoothly mount the filter unit while suppressing the leakage of the liquid.

[12] The liquid ejection apparatus according to any one of the above [1] to may further include a carriage configured to support and move the liquid ejection head, and the mounting portion may be provided on the carriage.

According to this configuration, the mounting portion is provided in the carriage. Therefore, by moving the carriage, the filter unit can be easily moved to, for example, a position where the filter unit is easily attached and detached.

[13] In the liquid ejection apparatus according to any one of the above [1] to , the first introduction portion may be located above the first lead-out portion in a vertical direction.

According to this configuration, the first introduction portion is located above the first lead-out portion. The first lead-out portion sends the liquid led out from the filter unit to the liquid ejection head. Therefore, the supply flow path that supplies the liquid to the filter unit can be easily routed at a position away from the liquid ejection head.

[14] In the liquid ejection apparatus according to any one of the above [1] to , the filter unit may include a pressure regulating mechanism configured to regulate a pressure in the liquid ejection head, and the pressure regulating mechanism may be located downstream of the filter in a liquid supply direction.

According to this configuration, the filter unit includes the pressure regulating mechanism located downstream of the filter. The pressure regulating mechanism can regulate the pressure in the liquid ejection head. That is, for example, when the liquid ejection head ejects the liquid and the pressure in the liquid ejection head changes, the pressure regulating mechanism supplies the liquid and regulates the pressure. The pressure regulating mechanism stops the supply of the liquid when the liquid ejection head does not eject the liquid. Therefore, when the filter unit is detached, since the pressure regulating mechanism stops the supply of the liquid, it is possible to reduce the possibility that the liquid leaks from the detached filter unit.

What is claimed is:

1. A liquid ejection apparatus comprising:
a liquid ejection head configured to eject a liquid;
a supply flow path configured to supply the liquid to the liquid ejection head;
a filter unit provided in the supply flow path; and
a mounting portion on which the filter unit is detachably mounted, wherein
the filter unit includes
a filter configured to collect foreign matter,
a first introduction portion configured to introduce the liquid into the filter unit, and
a first lead-out portion configured to lead out the liquid from the filter unit,
the mounting portion includes
a second lead-out portion to which the first introduction portion is connected, and
a second introduction portion to which the first lead-out portion is connected,
the second introduction portion has a second introduction port,
the second lead-out portion includes
a second lead-out port opening in the same direction as the second introduction port, and
a second lead-out valve configured to open and close the second lead-out port, and
the second lead-out valve moves to an open position as the filter unit is mounted on the mounting portion, and moves to a closed position as the filter unit is detached from the mounting portion.

2. The liquid ejection apparatus according to claim 1, wherein
the first introduction portion includes a first introduction port and a first introduction valve configured to open and close the first introduction port, and
the first introduction valve moves to an open position as the filter unit is mounted on the mounting portion, and moves to a closed position as the filter unit is detached from the mounting portion.

3. The liquid ejection apparatus according to claim 2, wherein
the second lead-out portion includes a first pressing portion, and
when the filter unit is mounted on the mounting portion,
the second lead-out valve is pressed by the first introduction valve to move to the open position, and
the first introduction valve is pressed by the first pressing portion to move to the open position.

4. The liquid ejection apparatus according to claim 1, wherein
when the filter unit moves in a detachment direction, the second lead-out valve moves in the detachment direction and is located at the closed position, and
when the filter unit moves in a mounting direction opposite to the detachment direction, the second lead-out valve moves in the mounting direction and is located at the open position.

5. The liquid ejection apparatus according to claim 1, wherein
when the filter unit is mounted on the mounting portion,
the first introduction portion is located ahead of the second lead-out portion in a detachment direction, and
the first lead-out portion is located ahead of the second introduction portion in the detachment direction.

6. The liquid ejection apparatus according to claim 5, wherein
the second lead-out portion and the second introduction portion are located at different positions in the detachment direction.

7. The liquid ejection apparatus according to claim 4, wherein
the mounting portion includes a case portion configured to accommodate the filter unit, and
the filter unit is separated from the case portion by moving in the detachment direction and accommodated in the case portion by moving in the mounting direction.

8. The liquid ejection apparatus according to claim 7, further comprising:
a plurality of the filter units, wherein
the case portion is configured to accommodate the plurality of filter units, and
each of the filter units is individually attachable and detachable.

9. The liquid ejection apparatus according to claim 1, wherein
the second introduction portion includes a second introduction valve configured to open and close the second introduction port, and
the second introduction valve moves to an open position as the filter unit is mounted on the mounting portion, and moves to a closed position as the filter unit is detached from the mounting portion.

10. The liquid ejection apparatus according to claim 9, wherein
the first lead-out portion includes a first lead-out port and a first lead-out valve configured to open and close the first lead-out port, and
the first lead-out valve moves to an open position as the filter unit is mounted on the mounting portion, and moves to a closed position as the filter unit is detached from the mounting portion.

11. The liquid ejection apparatus according to claim 10, wherein
the second introduction portion includes a second pressing portion, and
when the filter unit is mounted on the mounting portion,
the second introduction valve is pressed by the first lead-out valve to move to the open position, and
the first lead-out valve is pressed by the second pressing portion to move to the open position.

12. The liquid ejection apparatus according to claim 1, further comprising:
a carriage configured to support and move the liquid ejection head, wherein
the mounting portion is provided on the carriage.

13. The liquid ejection apparatus according to claim 12, wherein
the first introduction portion is located above the first lead-out portion in a vertical direction.

14. The liquid ejection apparatus according to claim 1, wherein
the filter unit includes a pressure regulating mechanism configured to regulate a pressure in the liquid ejection head, and
the pressure regulating mechanism is located downstream of the filter in a liquid supply direction.
